(19) United States
(12) Patent Application Publication
(10) Pub. No.: US 2015/0211282 A1
(43) Pub. Date: Jul. 30, 2015

(54) System for remotely opening a door on a canvas car shelter

(71) Applicant: Fernand Potvin, Riviere du Loup (CA)

(72) Inventor: Fernand Potvin, Riviere du Loup (CA)

(21) Appl. No.: 14/166,990

(22) Filed: Jan. 29, 2014

(51) Int. Cl. E05F 15/603; E04H 15/34

(52) U.S. Cl. CPC E05F 15/603; E04H 15/34

(57) ABSTRACT

A system for remotely opening a door on a canvas car shelter has two spaced vertical internal support rods adapted to be attached at upper ends thereof to respective spaced portions of an upper horizontal support rod of the rib frame. Each of the internal support rod has an adjustable bracket member attached at a lower end thereof adapted to be adjustably attached to respective spaced base member portions of the rib frame.

A lower horizontal rod has a slide support member on each opposite end thereof adapted to slide along the length of each respective vertical internal support rod, wherein a lower edge of the flap door of the canvas car shelter assembly can be attached thereto and pulled up and down along the length of the vertical internal support rods thereby opening and closing the flap door. A remotely actuated motor adapted to be attached to an upper portion of the rib frame and including a double pulley member mechanically attached thereto and adapted to rotate in two opposite directions to thereby open and close the flap door. A pair of frame pulleys adapted to be attached to respective end portions of the upper horizontal support rod of the rib frame. A pair of wire members respectively attached at one end to a respective slide support member of the lower horizontal rod, looped around a respective frame pulley, and attached at an opposite end to a respective pulley portion of the double pulley member.

This application claims priority based on request GB1301779.3 Jan. 31. 2013

### FIELD OF THE INVENTION

The present invention relates generally to temporary shelter structures, but more particularly to a device for remotely opening a door on a canvas car shelter.

### BACKGROUND OF THE INVENTION

Garage tents or shelter are generally used in areas where snow is abundant and the driveway is often converted into a garage for the winter months. This eliminates the need for users to shovel their driveway. As well as protects their cars from snow, sleet and wind. These shelters are available in a variety of sizes and shapes that provides protection of one or more vehicles.

The doors of these shelters are made of the same material as the rest of the shelter and must be manually opened and closed, which can be a laborious process, which results in the flap door remaining open and snow, sleet, and ice enters into the shelter, which defeats its purpose. There is therefore a need for a better method of opening and closing these doors canvas car garage.

### SUMMARY OF THE INVENTION

In view of the foregoing disadvantages inherent in the known devices now present in the prior art, the present invention, which will be described subsequently in greater detail, is to provide objects and advantages which are:

To provide for a remote method system for opening and closing a door canvas carports.

In order to do so, the invention has two spaced vertical internal support rods adapted to be attached at upper ends thereof to respective spaced portions of an upper horizontal support rod of the rib frame. Each of the internal support rod has an adjustable bracket member attached at a lower end thereof adapted to be adjustably attached to respective spaced base member portions of the rib frame.

A lower horizontal rod has a slide support member on each opposite end thereof adapted to slide along the length of each respective vertical internal support rod, wherein a lower edge of the flap door of the canvas car shelter assembly can be attached thereto and pulled up and down along the length of the vertical internal support rods thereby opening and closing the flap door. A remotely actuated motor adapted to be attached to an upper portion of the rib frame and including a double pulley member mechanically attached thereto and adapted to rotate in two opposite directions to thereby open and close the flap door. A pair of frame pulleys adapted to be attached to respective end portions of the upper horizontal support rod of the rib frame. A pair of wire members respectively attached at one end to a respective slide support member of the lower horizontal rod, looped around a respective frame pulley, and attached at an opposite end to a respective pulley portion of the double pulley member, to thereby displace the slide support members along the internal support rods when the motor is remotely actuated.

The system is further comprised of a pair of slide support member pulleys, each respectively attached to a slide support member, such that each of the pair of wire members is looped around a respective slide support member pulley and then adapted to be attached to a portion of the rib frame to thereby increase the displacement of each slide support member per rotation of the double pulley member of the remotely actuated motor.

Each of the adjustable bracket member comprises at least two slide member portions connected via a locking member, such that the length of each of the adjustable bracket member can be changed and adapted to accommodate differently sized rib frames.

The system has each of the adjustable bracket member further include an angle bracket member portion adapted to be connected to a portion of the rib frame spaced from the respective base member portion and thereby adapted to increase the strength and rigidity between each the internal support rod and the rib frame.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of a garage tent and components.

FIG. 2a Isometric view of garage tent.

FIG. 2b Detail view of motor. 20[0018] FIG. 2c Detail view of top fittings.

FIG. 2d Reverse angle view detail of top fittings.

FIG. 2e Detail view of bottom fittings.

FIG. 2f Detail view of garage tent flap attachments.

FIG. 3a-c Isometric view from the inside of the garage tent and details.

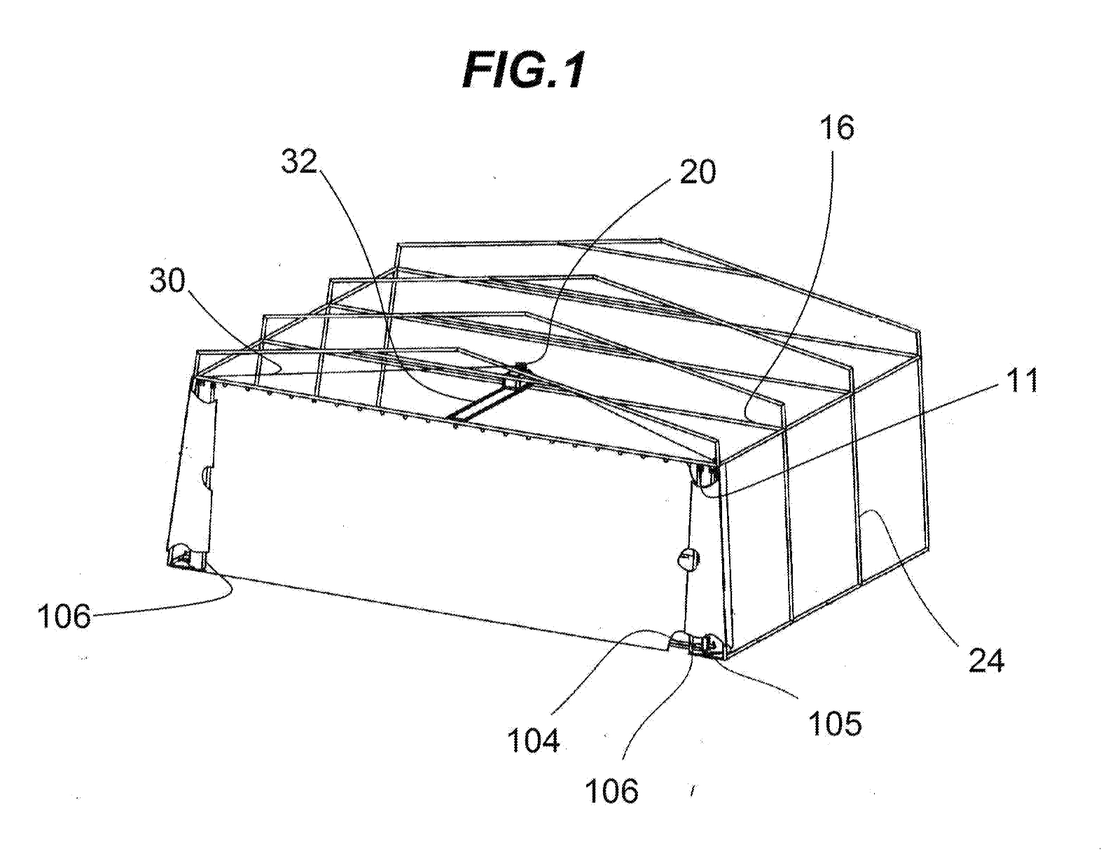

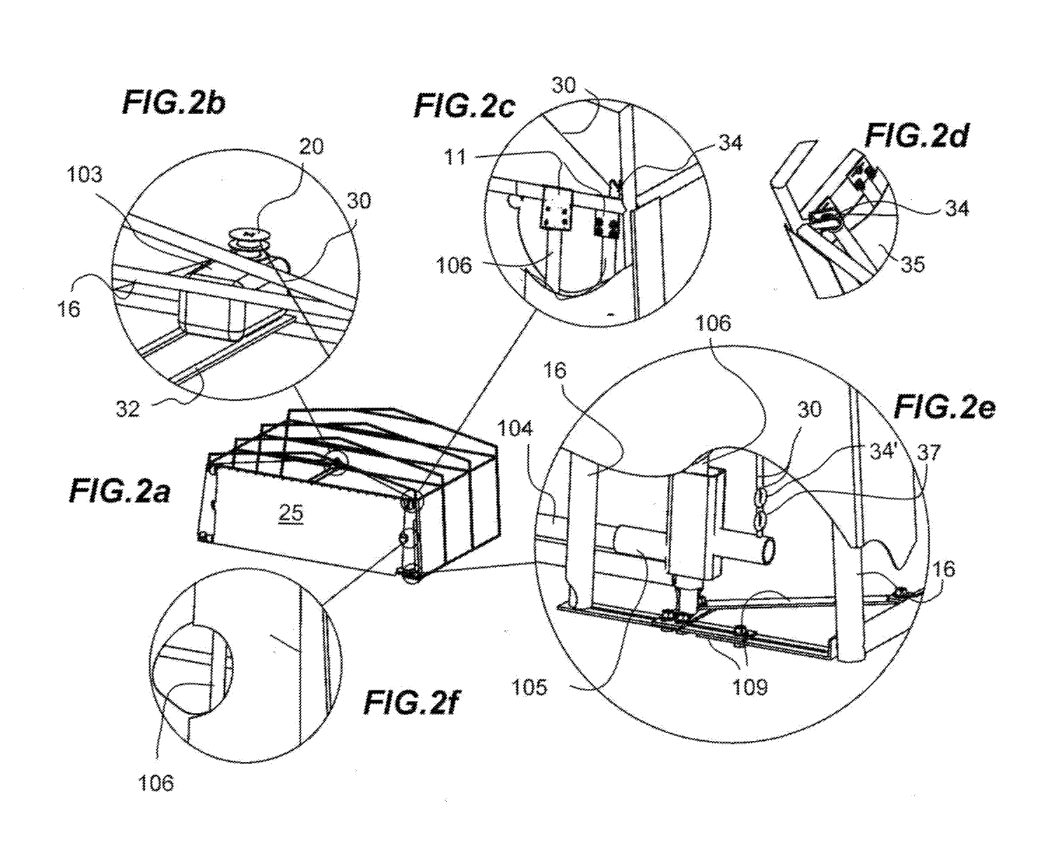

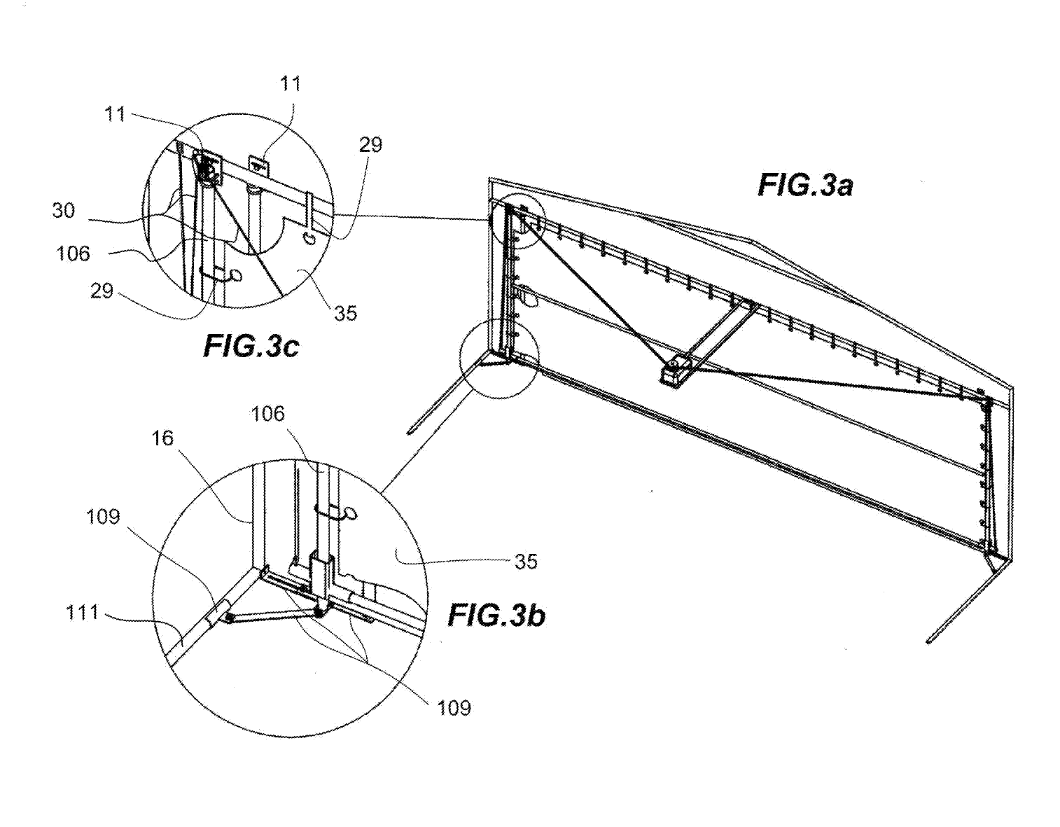

### DETAILED DESCRIPTION OF THE PREFERRED EMBODIMENT

A system for remotely opening a flap door (25) on a canvas car shelter (24) comprises a remotely actuated motor (103) provided with a double pulley member (20) attached to a pair of support members (32) onto a rib frame (16), forming part of the shelter (24). The rib frame (16) as well as canvas (34) are well known in the art of car shelters (24).

The remotely actuated motor (103) wraps or unwraps at least one wire (30) around a double pulley member (20). The wire member (30) goes into two direction, passes through a pair of frame pulleys (35) attached to the rib frame (16), and down through a second set of pulleys (37) attached proximal to a pair of slide support members (105) located on either side of the flap door (25), and up so that its two ends are fixedly attached to the rib frame (16). These slide support members (105) slide around a pair of internal support rods (106) and are connected to the lower horizontal rod (104) onto which the flap door (25) is attached. The advantage of using a second set of pulleys (37) is that the length of the pull by the wire (30) is cut in half. But the set second set of pulleys (37) could be eliminated and the ends of the wire member (30) could connect directly to the pair of slide supports (105). Also, a pair of wire members could easily substitute for the single wire member (30) while keeping the same operating principle.

When the remotely actuated motor (103) is activated, the wire member (30) raises the pair of slide brackets (105) along inner rods (106). The inner rods (106) have the flap door (24), attached to it by way of clip members (29). The inner rods (106) have their lower ends attached to an adjustable bracket (109) which is itself attached to a base member (111) forming part of the rib frame (16). The inner rods (106) have their upper ends attached to the upper part of the rib frame (16) by way of attachment brackets (11). The flap door (24) rises vertically and folds as it does.

Reversing the operation obviously results in the lowering of the flap door (24). The remote control unit (not shown) and all associated electronics (not shown) are well known in the art and need not be discussed herein.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for remotely opening a flap door of a canvas car shelter assembly having a rib frame, said system comprising two spaced vertical internal support rods adapted to be attached at upper ends thereof to respective spaced portions of an upper horizontal support rod of said rib frame; each said internal support rod having an adjustable bracket member attached at a lower end thereof adapted to be adjustably attached to respective spaced base member portions of said rib frame; a lower horizontal rod having a slide support member on each opposite end thereof adapted to slide along the length of each respective vertical internal support rod, wherein a lower edge of said flap door of said canvas car shelter assembly can be attached thereto and pulled up and down along the length of said vertical internal support rods thereby opening and closing said flap door; a remotely actuated motor adapted to be attached to an upper portion of said rib frame and including a double pulley member mechanically attached thereto and adapted to rotate in two opposite directions to thereby open and close said flap door; a pair of frame pulleys adapted to be attached to respective end portions of said upper horizontal support rod of said rib frame; and a pair of wire members respectively attached at one end to a respective slide support member of said lower horizontal rod, looped around a respective frame pulley, and attached at an opposite end to a respective pulley portion of said double pulley member, to thereby displace said slide support members along said internal support rods when said motor is remotely actuated.

2. The system of claim 1, further comprising a pair of slide support member pulleys each respectively attached to a slide support member, such that each of said pair of wire members is looped around a respective slide support member pulley and then adapted to be attached to a portion of said rib frame to thereby increase the displacement of each slide support member per rotation of said double pulley member of said remotely actuated motor.

3. The system of claim 1, wherein each said adjustable bracket member comprises at least two slide member portions connected via a locking member, such that the length of each said adjustable bracket member can be changed and adapted to accommodate differently sized rib frames.

4. The system of claim 1, wherein each said adjustable bracket member further includes an angle bracket member portion adapted to be connected to a portion of said rib frame spaced from the respective base member portion and thereby adapted to increase the strength and rigidity between each said internal support rod and said rib frame.

5. A canvas car shelter comprising a rib frame forming four walls, wherein a front wall of said four walls has an opening therein forming a doorway including an upper horizontal support rod, a roof portion, a canvas material attached to and covering said rib frame, and a canvas flap door attached to said upper horizontal support rod for selectively covering said doorway; and a system for remotely opening said flap door, said system comprising two spaced vertical internal support rods attached at upper ends thereof to respective spaced portions of said upper horizontal support rod of said rib frame; each said internal support rod having an adjustable bracket member attached at a lower end thereof and adjustably attached to respective spaced base member portions of said rib frame; a lower horizontal rod having a slide support member on each opposite end thereof adapted to slide along the length of each respective vertical internal support rod, wherein a lower edge of said flap door of said canvas car shelter assembly is attached thereto and pulled up and down along the length of said vertical internal support rods thereby opening and closing said flap door; a remotely actuated motor attached to said roof portion of said rib frame and including a double pulley member mechanically attached thereto and adapted to rotate in two opposite directions to thereby open and close said flap door; a pair of frame pulleys attached to respective end portions of said upper horizontal support rod of said rib frame; and a pair of wire members respectively attached at one end to a respective slide support member of said lower horizontal rod, looped around a respective frame pulley, and attached at an opposite end to a respective pulley portion of said double pulley member, to thereby displace said slide support members along said internal support rods when said motor is remotely actuated.

6. The canvas car shelter of claim 5, further comprising a pair of slide support member pulleys each respectively attached to a slide support member, such that each of said pair of wire members is looped around a respective slide support member pulley and then attached to a portion of said rib frame to thereby increase the displacement of each slide support member per rotation of said double pulley member of said remotely actuated motor.

7. The canvas car shelter of claim 5, wherein each said adjustable bracket member comprises at least two slide member portions connected via a locking member, such that the length of each said adjustable bracket member can be changed and adapted to accommodate differently sized rib frames.

8. The canvas car shelter of claim 5, wherein each said adjustable bracket member further includes an angle bracket member portion adapted to be connected to a portion of said rib frame spaced from the respective base member portion and thereby adapted to increase the strength and rigidity between each said internal support rod and said rib frame.

9. The canvas car shelter of claim 5, wherein said front wall includes two spaced vertical frame members defining side portions of said front wall and the width of said doorway and are attached at upper ends thereof to respective spaced portions of said upper horizontal support rod, wherein the distance between said attachment points of said two vertical frame members is less than the distance between the attachment points of said two spaced vertical internal support rods to said upper horizontal support rod, such that there is an overlap between side portions of said front wall and said flap door.

10. The canvas car shelter of claim 9, wherein each of said two spaced vertical frame members of said front wall are respectively attached at an opposite end to a said adjustable bracket member, to thereby be adjustable along with said vertical internal support rods.

11. The canvas car shelter of claim 5, wherein said canvas flap door is attached to said upper horizontal support rod and said lower horizontal rod via removable clip members.
